(19) United States
(12) Patent Application Publication
(10) Pub. No.: US 2018/0069250 A1
(43) Pub. Date: Mar. 8, 2018

(54) FUEL CELL SYSTEM AND ITS OPERATION METHOD

(71) Applicant: FUJI ELECTRIC CO., LTD., Kawasaki-shi (JP)

(72) Inventors: Hisanobu YOKOYAMA, Kawasaki-shi (JP); Shinya UI, Kawasaki-shi (JP); Yasutaka SANUKI, Kawasaki-shi (JP)

(73) Assignee: FUJI ELECTRIC CO., LTD., Kawasaki-shi (JP)

(21) Appl. No.: 15/694,002

(22) Filed: Sep. 1, 2017

(30) Foreign Application Priority Data
Sep. 6, 2016 (JP) 2016-173496

(51) Int. Cl. H01M 8/04007; H01M 8/12; H01M 8/04701; H01M 8/0432

(52) U.S. Cl. CPC H01M 8/04052; H01M 8/12; H01M 2008/1293; H01M 8/0432; H01M 8/04067; H01M 8/04701

(57) ABSTRACT

A fuel cell system includes a heater and a radiator provided in a waste heat recovery circulation line. The heater converts the surplus power of a solid oxide fuel cell into heat when a grid power network and the solid oxide fuel cell switch from the inter-connected state to the disconnected state. The radiator controls the temperature of the heat produced in the heater.

### CROSS REFERENCE TO RELATED APPLICATION

This application is based upon and claims the benefit of priority from the prior Japanese Patent Application No. 2016-173496, filed on Sep. 6, 2016; the entire contents of which are incorporated herein by reference.

### TECHNICAL FIELD

The present invention relates to a fuel cell system and a method of operating the same.

### BACKGROUND ART

In recent years, studies on solid oxide fuel cells (SOFC) have been in progress. An SOFC refers to a power generation mechanism, in which oxide ions generated at the air electrode move to the fuel electrode through the electrolyte, and react with hydrogen or carbon monoxide at the fuel electrode to produce electrical energy. The SOFC is characteristic in that its operating temperature upon power generation is the highest (for example, 900° C. to 1000° C.) and its power generation efficiency is the highest among the types of fuel cells known today.

Patent Literature 1 discloses a fuel cell system that is capable of inter-connected operation by getting inter-connected with a grid power supply, and that is also capable of stand-alone operation by getting disconnected from the grid power supply. During stand-alone operation, the power to be generated by the fuel cell is set to stand-alone-generated power of a certain level, which is less than the maximum rated power, and which is greater than the idling power that is necessary to drive the accessories.

The above fuel cell system switches from inter-connected operation to stand-alone operation when the grid power supply has a power outage, and, during the standby period that lasts from the switching to the beginning of operation, the fuel cell system consumes surplus power, apart from the idling power, in a surplus power heater, without supplying power to external loads, so that the power to be generated by the fuel cell is kept at stand-alone generated power.

### CITATION LIST

### Patent Literature

Patent Literature 1: Japanese Patent Application Publication No. 2015-186408

### SUMMARY OF INVENTION

### Technical Problem

However, with the fuel cell system of patent literature 1, during the standby period upon a switch from inter-connected operation to stand-alone operation, the quantity of heat that is consumed as surplus power in the surplus power heater (the quantity of heat in the heater) becomes too high, locally, and the thermal balance of each reactor, including the surplus power heater, is lost. As a result of this, desired fuel cell system efficiency cannot be achieved, which makes it difficult to continue the operation, and troubles and failures of equipment may be induced.

The present invention has been made in view of the above, and it is therefore an object of the present invention to provide a fuel cell system that can achieve desired fuel cell system efficiency over a long period of time, and that, furthermore, can improve the durability and continue operating in a stable manner, by maintaining the thermal balance of each reactor in the system, and an operation method of the same.

### Solution to Problem

According to an embodiment of the present invention, one example of a fuel cell system has a solid oxide fuel cell that generates power by an electrochemical reaction of a fuel gas and an oxidant gas, a waste heat recovery circulation line, which is provided apart from the solid oxide fuel cell, and which recovers heat of a discharged gas from the solid oxide fuel cell, a grid inter-connection relay, which is capable of switching between an inter-connected state and a disconnected state of the solid oxide fuel cell and a grid power network, a surplus power conversion unit, which is provided in the waste heat recovery circulation line, and which converts surplus power, which is part of the power generated by the solid oxide fuel cell when the grid inter-connection relay switches from the inter-connected state to the disconnected state, into heat, and recovers the heat, a waste heat processing unit, which is provided in the waste heat recovery circulation line, and which, regardless of whether the grid inter-connection relay is in the inter-connected state or in the disconnected state, receives a supply of power from the solid oxide fuel cell or the grid power network, and controls a temperature of a heat medium that flows in the waste heat recovery circulation line and releases the recovered heat to outside of the fuel cell system, and a control unit that controls the solid oxide fuel cell, the waste heat recovery circulation line, the surplus power conversion unit and the waste heat processing unit.

According to an embodiment of the present invention, one example of a method of operating a fuel cell system having a solid oxide fuel cell that generates power by an electrochemical reaction of a fuel gas and an oxidant gas, a waste heat recovery circulation line, which is provided apart from the solid oxide fuel cell, and which recovers heat of a discharged gas from the solid oxide fuel cell, and a grid inter-connection relay, which is capable of switching between an inter-connected state and a disconnected state of the solid oxide fuel cell and a grid power network includes a surplus power conversion step of converting surplus power, which is part of the power generated by the solid oxide fuel cell when the grid inter-connection relay switches from the inter-connected state with the solid oxide fuel cell to the disconnected state, into heat, and recovering the heat, in a surplus power conversion unit provided in the waste heat recovery circulation line, a waste heat processing step of receiving a supply of power from the solid oxide fuel cell or the grid power network and controlling a temperature of a heat medium that flows in the waste heat recovery circulation line and releasing the recovered heat to outside of the fuel cell system, regardless of whether the grid inter-connection relay is in the inter-connected state with the solid oxide fuel cell or in the disconnected state, in a waste heat processing unit provided in the waste heat recovery circulation line, and a control step of controlling the surplus power conversion step and the waste heat processing step.

### Advantageous Effects of Invention

According to the present invention, it is possible to provide a fuel cell system that can achieve desired fuel cell system efficiency over a long period of time, and that, furthermore, can improve the durability and continue operating in a stable manner, by maintaining the thermal balance of each reactor in the system, and an operation method of the same.

### BRIEF DESCRIPTION OF DRAWINGS

FIG. 1 is a block diagram to show a fuel cell system according to a first embodiment;

FIG. 2 is a block diagram to show an internal configuration of a waste heat recovery circulation system according to the first embodiment;

FIG. 3A is the block diagram of FIG. 1, compatible with inter-connected operation between an SOFC and a grid power network;

FIG. 3B is the block diagram of FIG. 1, compatible with stand-alone operation of an SOFC;

FIG. 4 is a block diagram to show an internal configuration of a waste heat recovery circulation system according to a second embodiment; and

FIG. 5 is a flowchart to show the operation of the waste heat recovery circulation system according to the second embodiment.

### DESCRIPTION OF EMBODIMENTS

### First Embodiment

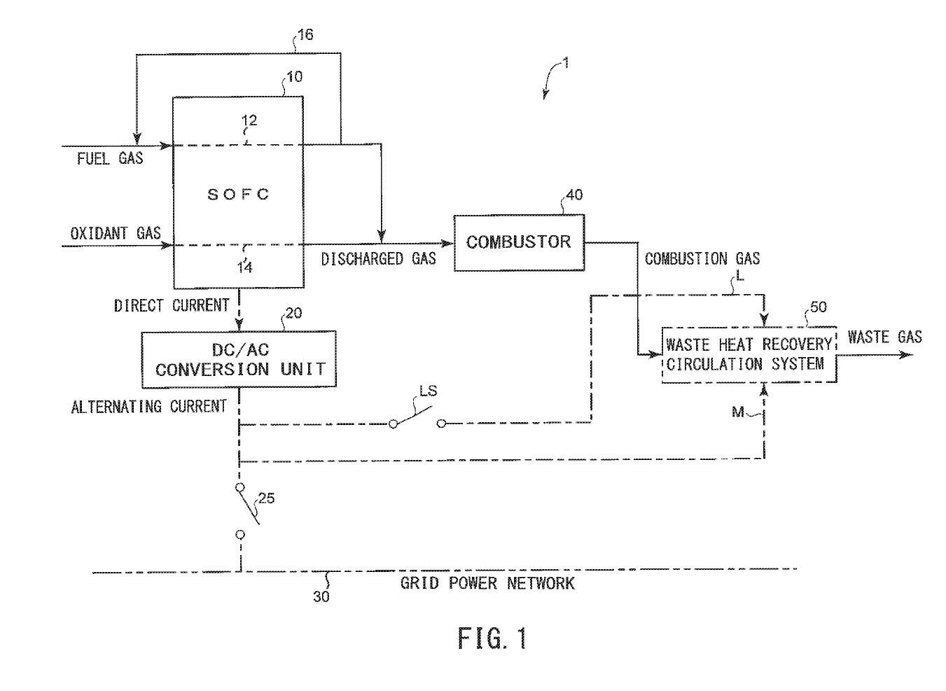

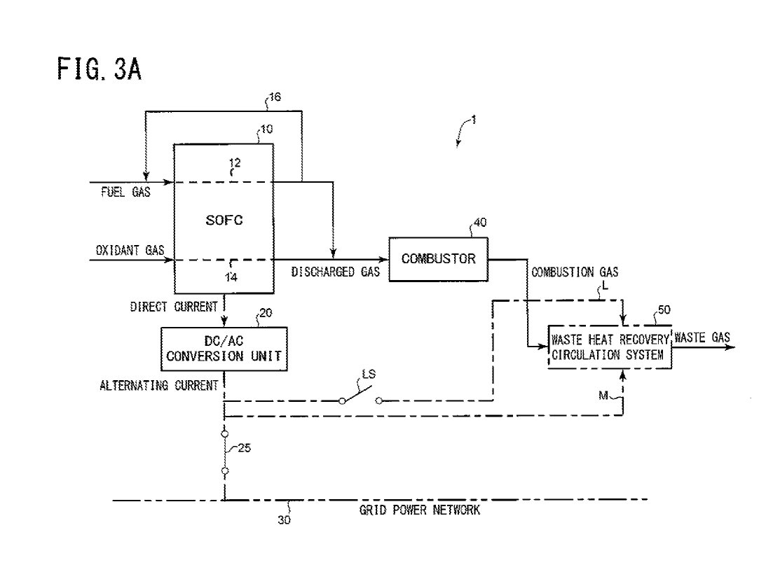

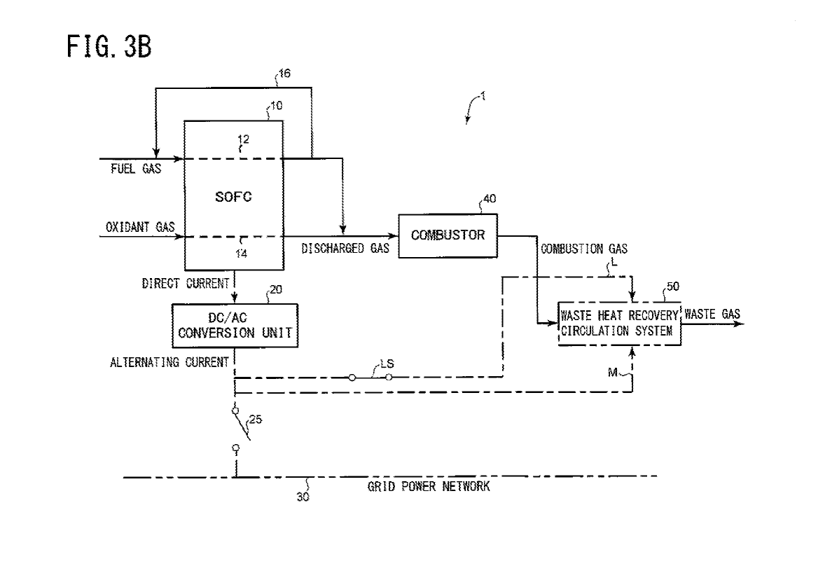

Now, the fuel cell system 1 of the first embodiment will be described in detail with reference to FIG. 1 to FIG. 3 (FIG. 3A and FIG. 3B). In the drawings, the solid lines (outside the SOFC 10) and the coarse dashed lines (inside the SOFC 10) indicate flows of fluids such as gases and water, the alternate long and short dashed lines indicate flows of electricity (current, power. etc.), and the delicate broken lines indicate flows of various signals such as control signals and detection signals.

As shown in FIG. 1, the fuel cell system 1 has a solid oxide fuel cell (SOFC) 10, a DC/AC conversion unit 20, a grid power network 30, a combustor 40 and a waste heat recovery circulation system 50.

The SOFC 10 has a cell stack, in which a plurality of cells are stacked or formed as an aggregate. Each cell has a basic structure, in which an electrolyte is sandwiched between an air electrode and a fuel electrode, and a separator is interposed between each cell. Each cell of the cell stack is electrically connected in series. The SOFC 10 is a power generation mechanism, in which oxide ions generated at the air electrode move to the fuel electrode through the electrolyte, and react with hydrogen or carbon monoxide at the fuel electrode to produce electrical energy.

The SOFC 10 has a fuel gas channel (anode gas channel) 12 and an oxidant gas channel (cathode gas channel) 14. A fuel gas is supplied in the fuel gas channel 12 from a fuel gas supply unit (not shown), and an oxidant gas is supplied in the oxidant gas channel 14 from an oxidant gas supply unit (not shown). The fuel gas supplied to the fuel gas channel 12 and the oxidant gas supplied to the oxidant gas channel 14 undergo an electrochemical reaction, and thereupon a direct current is produced. The fuel gas and the oxidant gas that do not undergo an electrochemical reaction are discharged as discharged gases from the SOFC 10. Part of the fuel gas that is discharged from the SOFC 10 is returned to the fuel gas channel 12 via a recycle gas channel 16.

The DC/AC conversion unit 20 converts the direct current produced by the SOFC 10 (power generation) into an alternating current.

The power generated in the SOFC 10 passes through the DC/AC conversion unit 20, and is connected to the grid power network 30 via a grid inter-connection relay 25. When the grid inter-connection relay 25 is in the ON state, the power generated in the SOFC 10 enters the inter-connected state with the grid power network 30, and, when the grid inter-connection relay 25 is in the OFF state, the disconnected state is assumed, and the SOFC 10 works in stand-alone operation.

During inter-connected operation, the power generated by the SOFC 10 is supplied to the grid, and, during stand-alone operation, the generated power is consumed within the device with load smaller than the maximum rated power.

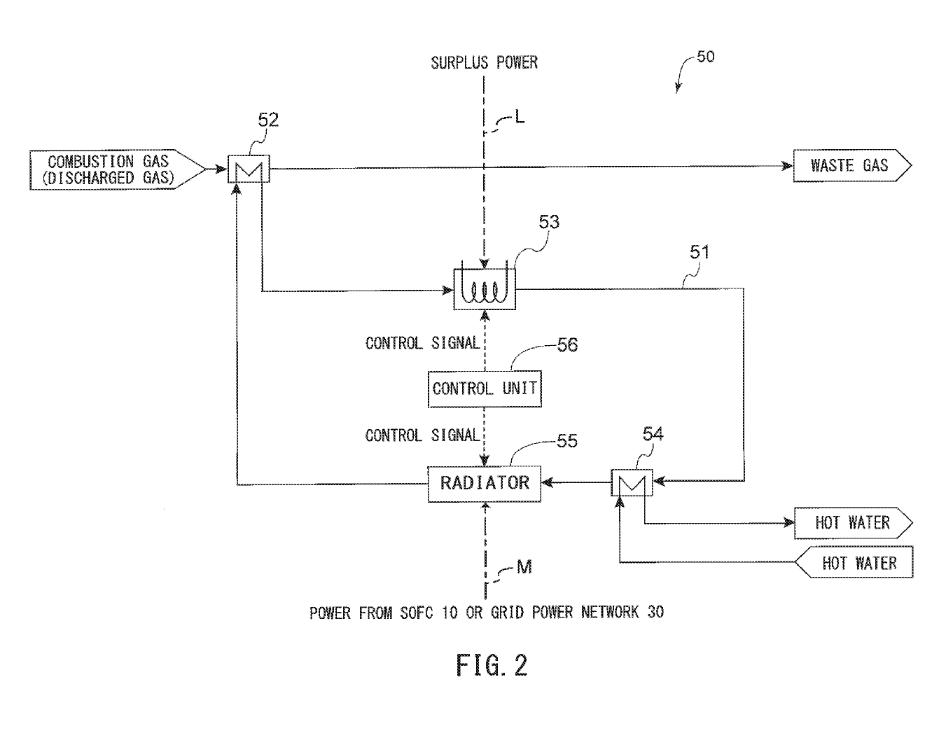

From the power channel between the DC/AC conversion unit 20 and the grid inter-connection relay 25, a surplus power channel L for transmitting surplus power, which is part of the power that is generated by the SOFC 10 when the grid power network 30 (grid inter-connection relay 25) switches from the inter-connected state with the SOFC 10 to the disconnected state, branches out. This surplus power channel L is connected to a heater (surplus power conversion unit) 53, which is provided in a waste heat recovery circulation line 51 of the waste heat recovery circulation system 50 (described later) (see FIG. 2).

A relay switch LS is provided in the surplus power channel L. When the relay switch LS is in the ON state, surplus power can be transmitted to the heater 53 via the surplus power channel L, and, when the relay switch LS is in the OFF state, the surplus power channel L is cut off, and surplus power cannot be transmitted to the heater 53.

Further, a power channel M branches out from the power channel between the DC/AC conversion unit 20 and the grid inter-connection relay 25. This power channel M is connected to a radiator (waste heat processing section) 55, which is provided in the waste heat recovery circulation line 51 of the waste heat recovery circulation system 50 (described later) (see FIG. 2). Power is supplied from the SOFC 10 or the grid power network 30 to this radiator 55 via the power channel M, so that the radiator 55 can operate regardless of the inter-connection/disconnected state with the grid power network 30. Like the radiator 55, the equipment that is mounted in the fuel cell system 1, such as the DC/AC conversion unit 20, a pump, a blower and so on (not shown) are supplied with power from either the SOFC 10 or the grid power network 30 via the power channel M and driven. Also, the surplus power that is transmitted through the surplus power channel L is part of the generated power that is necessary to maintain the operating temperature of the SOFC 10, and greater than the power that is necessary to drive the equipment mounted in the fuel cell system 1.

For example, the grid inter-connection relay 25 and the relay switch LS are controlled so that, when one is in the ON state, the other is in the OFF state. Of course, the grid inter-connection relay 25 and the relay switch LS may be controlled so that there is a duration of time in which both are in the ON state or in the OFF state. FIG. 1 illustrates a case where both the grid inter-connection relay 25 and the relay switch LS are in the OFF state.

The combustor 40 burns the discharged gas discharged from the SOFC 10 to remove the fuel components that remain in this discharged gas.

As shown in FIG. 2, the waste heat recovery circulation system 50 has a waste heat recovery circulation line 51 for recovering the heat of the combustion gas (discharged gas) from the combustor 40. In the waste heat recovery circulation line 51, water (hot water) circulates as a heat medium for recovering the waste heat. The gas after waste heat is recovered by the waste heat recovery circulation system 50 (waste heat recovery circulation line 51) is exhausted to the outside of the fuel cell system 1.

In the waste heat recovery circulation line 51, a waste heat recovery heat exchanger 52, a heater (surplus power conversion unit) 53, a hot water heat exchanger 54 and a radiator (waste heat processing unit) 55 are provided. Although not shown, in the waste heat recovery circulation line 51 or in the vicinity thereof, a pump for circulating water (hot water) may be installed where necessary. Control signals are sent from a control unit 56 to the equipment mounted in the fuel cell system, including the heater 53 and the radiator 55, respectively.

The waste heat recovery heat exchanger 52 uses the heat of the combustion gas (discharged gas) from the combustor 40 to heat the water (hot water) that flows in the waste heat recovery circulation line 51.

The heater 53 heats the water (hot water) that flows in the waste heat recovery circulation line 51 by converting the surplus power, which is transmitted from the surplus power channel L when the inter-connected state switches to the disconnected state, into heat.

The hot water heat exchanger 54 further heats water (hot water) that circulates from an external tank and/or the like (not shown) by using the heat of the water (hot water) flowing in the waste heat recovery circulation line 51.

The radiator 55 cools the water (hot water) that flows in the waste heat recovery circulation line 51. The water (hot water) that flows in the waste heat recovery circulation line 51 is cooled by the radiator 55, and the hot water inlet temperature of the waste heat recovery heat exchanger 52 is controlled to a predetermined temperature. Ultimately, the heat that is recovered by converting the surplus power into heat (the heat that is recovered by controlling the temperature of water (hot water), which is the heat medium that flows in the waste heat recovery circulation line 51) is released to the outside of the fuel cell system 1.

The control unit 56 drives and controls each of the equipment mounted in the fuel cell system such as the heater 53 and the radiator 55. For example, when the grid power network 30 is in the inter-connected state with the SOFC 10, the control unit 56 places the heater 53 in the non-driving state, and, when the grid power network 30 switches from the inter-connected state with the SOFC 10 to the disconnected state, the control unit 56 switches the heater 53 from the non-driving state to the driving state. The control unit 56 can, for example, place the radiator 55 in the driving state, irrespective of whether the grid power network 30 is in the inter-connected state with the SOFC 10 or in the disconnected state. Alternatively, the control unit 56 may switch between the driving state and the non-driving state of the radiator 55 depending on whether the grid power network 30 is in the inter-connected state with the SOFC 10 or in the disconnected state. That is, the control unit 56 has a certain degree of freedom in the way of controlling the drive of the radiator 55, and various changes in the design are also possible. The control unit 56 includes control circuitry, including a processing element such as a central processing unit (CPU), field programmable gate array (FPGA), or any other programmable-type chip. The control unit 56 includes input leads or connectors to receive input signals and output lines to control the heater 53 and the radiator 55. The control unit 56 may also include a counter or other timing circuitry to generate output signals after a predetermined delay, according to design specifications for controlling the heater 53 and the radiator 55. The control unit 56 may also include comparators to compare input signals to reference signals, and to control the heater 53 and the radiator 55 according to the comparison. For example, as described below, the control unit 56 may receive as an input a temperature detection signal and may drive the heater 53 and the radiator 55 according to a detected temperature.

As shown in FIG. 3A, during inter-connected operation of the SOFC 10 and the grid power network 30, the grid inter-connection relay 25 enters the ON state, and the relay switch LS enters the OFF state. Therefore, surplus power is not transmitted to the waste heat recovery circulation system 50 through the surplus power channel L (surplus power itself is not even produced), and the heater 53 provided in the waste heat recovery circulation line 51 is kept in the non-driving state.

As shown in FIG. 3B, when inter-connected operation between the SOFC 10 and the grid power network 30 switches to stand-alone operation of the SOFC 10, the grid inter-connection relay 25 enters the OFF state and the relay switch LS enters the ON state. Then, surplus power is transmitted to the waste heat recovery circulation system 50 through the surplus power channel L, and the heater 53 provided in the waste heat recovery circulation line 51 switches from the non-driving state to the driving state, so that the surplus power is converted into heat (power generation load of the fuel cell system 1 is achieved).

Here, although, during stand-alone operation of the SOFC 10, the heater 53 is driven in addition to the waste heat recovery heat exchanger 52, it is possible to control the temperature of the heat that is produced by the operation of the heater 53 by driving the radiator 55 in synchronization with the operation of the heater 53. Consequently, the temperature of the water (hot water) that is heated by the operation of the heater 53 and flows through the waste heat recovery circulation line 51 does not become too high, and can be controlled in the same way as during inter-connected operation of the SOFC 10 and the grid power network 30 (in which the heater 53 is not driven). Thus, by maintaining the thermal balance of each reactor inside the fuel cell system 1, it is possible to achieve desired system efficiency over a long period of time, and, furthermore, improve the durability and enable continuous stable operation.

Meanwhile, even during inter-connected operation of the SOFC 10 and the grid power network 30 (in which the heater 53 is not driven), if the hot water heat exchanger 54 is not driven, the temperature of the water (hot water) that flows in the waste heat recovery circulation line 51 may become too high. In order to prevent this, even when the heater 53 is not driven, the control unit 56 may lower the temperature of the water (hot water) that flows in the waste heat recovery circulation line 51 with the radiator 55.

### Second Embodiment

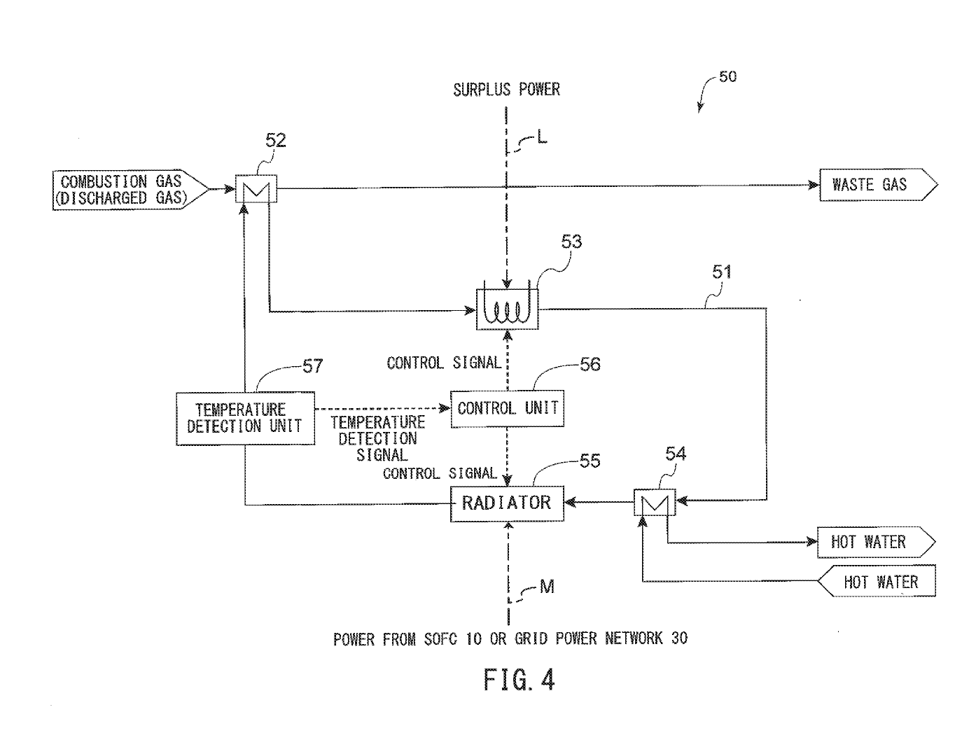

As shown in FIG. 4, in the waste heat recovery circulation system 50 of the second embodiment, a temperature detection unit 57 for detecting the temperature of water (hot water) that circulates in the waste heat recovery circulation line 51 is added to the waste heat recovery circulation line 51. The temperature detection unit 57 is connected to the control unit 56, and temperature detection signals to indicate the temperature of water (hot water) detected by the temperature detection unit 57 are sequentially sent to the control unit 56.

The control unit 56 controls the radiator 55 (for example, in PID control) so that the temperature of water (hot water) detected by the temperature detection unit 57 is lower than a predetermined value (for example, a predetermined value can be set from the range of 80° C. to 100° C.). That is, when the temperature of water (hot water) that flows in the waste heat recovery circulation line 51 becomes equal to or higher than a predetermined value due to the drive of the heater 53 during stand-alone operation of the SOFC 10, or when the temperature of water (hot water) that flows in the waste heat recovery circulation line 51 becomes equal to or higher than the predetermined value (or one step before that) while the hot water heat exchanger 54 is not driven during inter-connected operation of the SOFC 10 and the grid power network 30, the control unit 56 drives the radiator 55 so as to control the temperature of water (hot water) that flows in the waste heat recovery circulation line 51 to be lower than a predetermined value. For example, the control unit 56 increases the cooling capacity by increasing the rotation speed of the fan of the radiator 55, or adjusts the flow rate of the water (hot water) that flows in the waste heat recovery circulation line 51 or the water (hot water) that flows in the hot water heat exchanger 54.

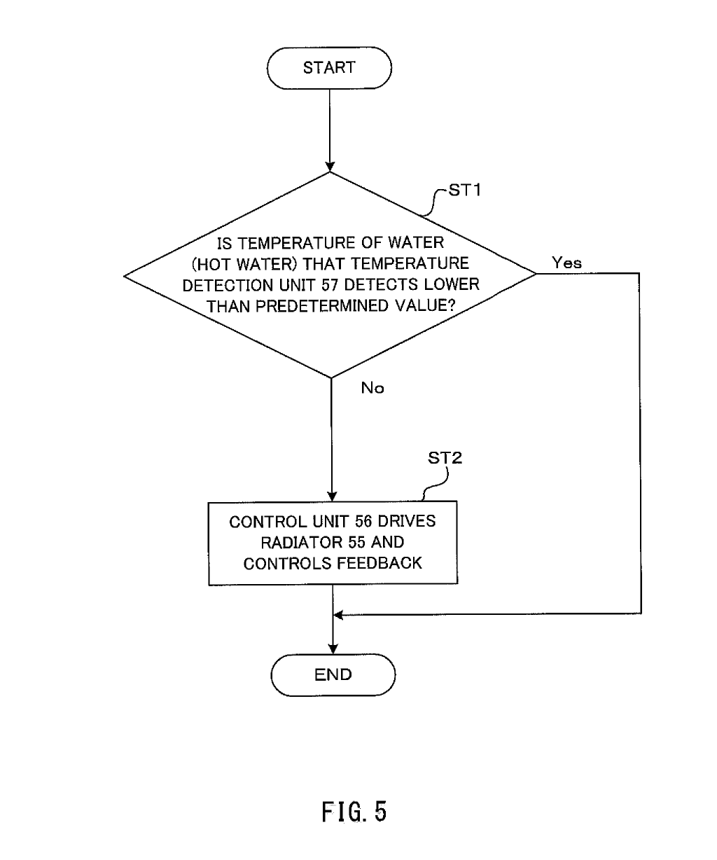

The operation of the waste heat recovery circulation system 50 of the second embodiment will be described with reference to the flowchart of FIG. 5.

In step ST1, the control unit 56 judges whether or not the temperature of water (hot water) detected by the temperature detection unit 57 is lower than a predetermined value. When the temperature of water (hot water) detected by the temperature detection unit 57 is less than the predetermined value (step ST1: Yes), the control unit 56 finishes the process. When the temperature of water (hot water) detected by the temperature detection unit 57 is equal to or higher than the predetermined value (Step ST1: No), the process moves on to step ST 2.

In step ST 2, the control unit 56 controls the radiator 55 so as to control the temperature of water (hot water) that flows in the waste heat recovery circulation line 51 to be lower than the predetermined value. That is, the temperature of water (hot water) that flows in the waste heat recovery circulation line 51 becomes equal to or higher than the predetermined value only once in the judging process of step ST 1 (step ST 1: No), and, after that, the temperature of water (hot water) that flows in the waste heat recovery circulation line 51 is kept below the predetermined value under the control of the control unit 56.

Note that the present invention is not limited to the above embodiments, and various changes can be made. The above embodiments are by no means limited to the size, shape, function and so on of each component shown in the attached drawings, and adequate changes can be made within the range the effect of the present invention can be achieved. Besides, various alterations can be implemented as appropriate without departing from the scope of the object of the present invention.

Although, in the above embodiment, the combustor 40 is provided between the SOFC 10 and the waste heat recovery circulation system 50, it is equally possible to omit this combustor 40, and guide the discharged gas discharged from the SOFC 10 directly to the waste heat recovery circulation system 50.

In the above embodiment, an example to use the heater 53 as a surplus power conversion unit and the radiator 55 as a waste heat processing unit has been shown, the surplus power conversion unit and the waste heat processing unit are by no means limited to the heater 53 and the radiator 55.

### INDUSTRIAL APPLICABILITY

The fuel cell system and the operation method of the same according to the present invention are suitable for application to fuel cell systems in domestic, commercial and other industrial fields.

1. A fuel cell system comprising:
a solid oxide fuel cell that generates power by an electrochemical reaction of a fuel gas and an oxidant gas;
a waste heat recovery circulation line, which is provided apart from the solid oxide fuel cell, and which recovers heat of a discharged gas from the solid oxide fuel cell;
a grid inter-connection relay configured to switch between an inter-connected state in which the solid oxide fuel cell is connected to a grid power network and a disconnected state in which the solid oxide fuel cell is disconnected from the grid power network;
a surplus power conversion unit, in the waste heat recovery circulation line, which converts surplus power, which is part of the power generated by the solid oxide fuel cell when the grid inter-connection relay is in the disconnected state, into heat, and recovers the heat;
a waste heat processing unit, in the waste heat recovery circulation line, which receives a supply of power from the solid oxide fuel cell in the disconnected state of the grid inter-connection relay, or from the grid power network in the inter-connected state of the grid inter-connection relay, and which, regardless of whether the grid inter-connection relay is in the inter-connected state or the disconnected state, controls a temperature of a heat medium that flows in the waste heat recovery circulation line and releases the recovered heat to outside of the fuel cell system; and
a control unit that controls the surplus power conversion unit and the waste heat processing unit to selectively drive the surplus power conversion unit and the waste heat processing unit.

2. The fuel cell system according to claim 1, further comprising a temperature detection section, which detects the temperature of the heat medium that circulates in the waste heat recovery circulation line,
wherein the control unit controls the waste heat processing unit so that the temperature of the heat medium detected by the temperature detection unit is maintained lower than a predetermined value.

3. The fuel cell system according to claim 1, wherein the control unit switches the surplus power conversion unit from a non-driving state to a driving state based on the grid inter-connection relay switching from the inter-connected state to the disconnected state.

4. The fuel cell system according to claim 1, wherein the surplus power conversion unit comprises a heater, and the waste heat processing unit comprises a radiator.

5. The fuel cell system according to claim 1, wherein the surplus power is generated power that is necessary to maintain the temperature of the solid oxide fuel cell, and that is greater than power that is necessary to drive equipment mounted in the fuel cell system.

6. A method of operating a fuel cell system comprising a solid oxide fuel cell that generates power by an electrochemical reaction of a fuel gas and an oxidant gas, a waste heat recovery circulation line, which is provided apart from the solid oxide fuel cell, and which recovers heat of a discharged gas from the solid oxide fuel cell, and a grid inter-connection relay, which is capable of switching between an inter-connected state and a disconnected state of the solid oxide fuel cell and a grid power network, the method comprising:
a surplus power conversion step of converting surplus power, which is part of the power generated by the solid oxide fuel cell when the grid inter-connection relay switches from the inter-connected state with the solid oxide fuel cell to the disconnected state, into heat, and recovering the heat, in a surplus power conversion unit provided in the waste heat recovery circulation line;
a waste heat processing step of receiving a supply of power from the solid oxide fuel cell or the grid power network and controlling a temperature of a heat medium that flows in the waste heat recovery circulation line and releasing the recovered heat to outside of the fuel cell system, regardless of whether the grid inter-connection relay is in the inter-connected state with the solid oxide fuel cell or in the disconnected state, in a waste heat processing unit provided in the waste heat recovery circulation line; and
a control step of controlling the surplus power conversion step and the waste heat processing step.
